(19) United States
(12) Patent Application Publication
(10) Pub. No.: US 2012/0131871 A1
(43) Pub. Date: May 31, 2012

(54) MOLDED DOOR, DOOR WITH LITE INSERT, AND RELATED METHODS

(76) Inventor: Jason W. CAULK, Tampa, FL (US)

(21) Appl. No.: 13/303,680

(22) Filed: Nov. 23, 2011

Related U.S. Application Data
(60) Provisional application No. 61/416,388, filed on Nov. 23, 2010.

(51) Int. Cl. E06B 3/54; E06B 3/00; B29C 59/02; E06B 7/00

(52) U.S. Cl. 52/455; 52/784.1; 49/506; 264/320

(57) ABSTRACT

A door assembly has a first door panel and a second door panel. The first door panel is made from a composite wood material and includes an exterior surface and an interior surface. The interior surface has a first door lite receiving region with a thickness less than at least one other region of the door panel. The second door panel is made from a composite wood material having an exterior surface and an interior surface. The interior surface has a second door lite receiving region with a thickness less than at least one other region of the door panel. The second door panel is attached to the first door panel to form a door and the first and second door lite receiving regions are aligned with one another.

### CROSS-REFERENCE TO RELATED APPLICATION AND CLAIM TO PRIORITY

This application is based on Provisional Application Ser. No. 61/416,388, filed on Nov. 23, 2010, which is incorporated herein by reference and to which the benefit of priority is claimed.

### FIELD OF THE INVENTION

The invention is directed to doors with lite inserts, especially transparent and translucent door lites, and methods of making and using the same.

### BACKGROUND

Doors are used in both interior and exterior applications. Conventional door assemblies are often made from a door frame and first and second door skins (also known in the art as door facings) secured on opposite sides of the door frame. Generally, door skins are classified as flush or molded. A flush door skin is generally characterized by flat/planar interior and exterior surfaces, wherein the interior surface is secured to the door frame and the exterior surface faces outward. Molded door skins, on the other hand, generally have contoured portions molded into at least the exterior surface. The molded portions may be, for example, ornamental interior panel moldings. Molded door skins tend to be relatively expensive in comparison to flush door skins, due in part to the greater capital cost of the mold dies used to shape the door skins during manufacturing.

Door skins are sometimes formed from wood composite materials. Common examples are particle board, flake board, hard board and medium density fiber board (“MDF”). The wood component of the wood composite material may be in the form of fibers, flakes, particles, dust, etc. A binder holds the wood components together to form the solid board. The binder is frequently is a thermosetting binder but may alternatively be a thermoplastic binder. Standard processes for manufacturing wood composite door skins involve compressing a relatively thick mat of binder and wood component into a thinner board member of smaller caliper, then drying the board member. Manufacturing processes may be wet, dry, or wet-dry.

After a pair of door skins have been manufactured, the door skins are assembled with other door components to form a completed door. These other door components can include stiles, rails, core pieces, hinge blocks, and lock blocks, by way of example. It is sometimes desirable for such doors to have a glazing unit, frequently provided in the form of a framed window assembly, or door lite, adapted to be mounted in a door. As referred to herein, a glazing unit or door lite may be transparent or translucent.

Some doors containing an array of door lites are commonly referred to as French doors. The door lites may be made of glass or other materials, including plastics.

### SUMMARY

In accordance with an embodiment, a door is provided that features composite wood first and second door panels. The first composite wood first door panel includes a first exterior surface and an opposite first interior surface, the first interior surface having a first door lite receiving region of a first reduced thickness compared to at least one other region of the first door panel. The composite wood second door panel includes a second exterior surface and an opposite second interior surface, the second interior surface has a second door lite receiving region with a second reduced thickness compared to at least one other region of the second door panel. The first and second door panels are secured to one another with the first and second door lite receiving regions aligned with one another.

In accordance with another embodiment, a door is provided that includes at least a composite wood, molded first door panel and a composite wood, molded second door panel. The composite wood, molded first door panel includes a first exterior surface and an opposite first interior surface, the first exterior and first interior surfaces each having a respective first inner region and a respective first outer region. The first inner region of the first interior surface is molded to establish a first door lite receiving region having a first reduced thickness compared to at least one other region of the first door panel having a first thickness. The composite wood, molded second door panel includes a second exterior surface and an opposite second interior surface, the second exterior and second interior surfaces each having a respective second inner region and a respective second outer region. The second inner region of the second interior surface is molded to establish a second door lite receiving region having a second reduced thickness compared to at least one other region of the second door panel having a second thickness. At least a portion of the first interior surface of the first panel is in direct surface-to-surface contact with at least a portion of the second interior surface of the second panel to form the door, and the first thickness and the second thickness combined constitute a total thickness of the door.

In accordance with another embodiment, a door is provided that includes at least a molded, composite wood first door panel and a molded, composite wood second door panel. The molded, composite wood first door panel includes a first exterior surface and a first interior surface, the first interior surface having a first channel extending from an edge of the first door panel. The molded, composite wood second door panel includes a second exterior surface and a second interior surface, the second interior surface having a second channel extending from an edge of the second door panel. The first and second channels are aligned with one another to form an entrance for receiving a door lite.

In accordance with a further embodiment, a method is provided for making a door panel. According to this embodiment, a wood composite blank having an interior surface and an exterior surface is molded to form a door panel having a compressed door lite receiving region in the interior surface. The door lite receiving region has a reduced thickness compared to at least one other region of the door panel.

In accordance with yet a further embodiment, a method is provided of making a door. According to this embodiment, first and second wood composites are molded into first and second door panels, the first and second door panels each having an interior surface with a door lite receiving region and an exterior surface. The first door panel and the second door panel are secured together to form a door. At least a portion of the interior surfaces of the first and second door panels contact one another and the first and second door lite receiving regions are aligned with each other.

### BRIEF DESCRIPTION OF THE DRAWINGS

FIG. 1 is an exploded, perspective view of a door assembly.

FIG. 2 is an exploded, perspective view of an exemplary alternative door assembly.

FIG. 3 is a perspective view an exemplary door panel.

FIG. 4 is an exploded, perspective view of an exemplary door assembly.

FIG. 5 is a sectional, perspective view of an exemplary door panel.

FIG. 6 is a perspective view of an exemplary door panel.

FIG. 7 is a top perspective view of an exemplary door assembly.

FIG. 8 is a perspective view of an exemplary door panel.

FIG. 9 is a perspective, sectional view an exemplary door panel.

FIG. 10 is an exploded, perspective view of an exemplary door panel with door lite.

FIG. 11 is a perspective view of an exemplary door panel.

FIG. 12 is a perspective view of an exemplary door panel.

FIG. 13 is an exploded, perspective view of an exemplary door panel with inserts.

FIG. 14 is an elevational view of an exemplary door panel.

FIG. 15 is a top view of the exemplary door panel of FIG. 14.

FIG. 16 is an elevational view of an exemplary door panel.

FIG. 17 is a top view of the exemplary door panel of FIG. 16.

FIG. 18 is an elevational view of an exemplary door panel.

FIG. 19 is a top perspective view of the exemplary door panel of FIG. 18.

### DETAILED DESCRIPTION OF EXEMPLARY EMBODIMENT(S) AND EXEMPLARY METHOD(S)

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

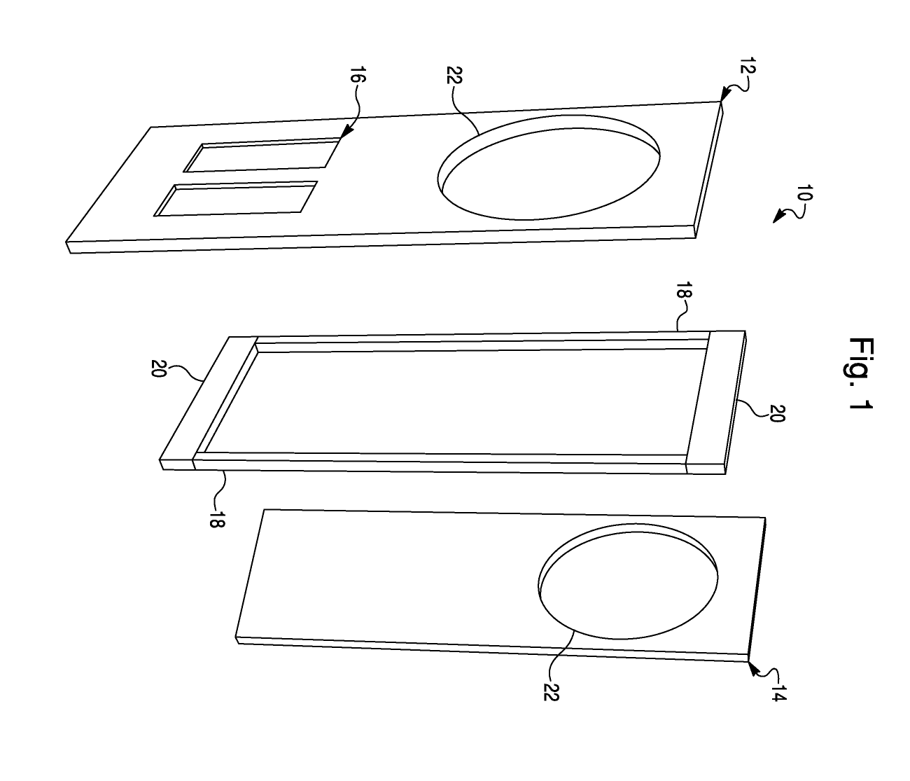

FIG. 1 shows a molded door assembly 10 including a first door skin 12 and a second door skin 14. The door skins 12, 14 contain at least one molded design element 16, such as an ornamental internal panel molding. The skins 12, 14 are attached, such as with an adhesive, to a rectangular frame including a pair of stiles 18 and a pair of rails 20. The skins 12, 14 may also have at least one opening 22 for receiving a door lite assembly (not shown in FIG. 1). The opening 22 may be formed by routing the door skins 12, 14. Various designs of door lite assemblies may be presented. The door lite assembly may include, for example, a door lite frame and a transparent or translucent door lite. The interior of the door assembly 10 may be hollow or it may have a core (not shown). The core can be a variety of materials such as a sprayed foam material or a molded foam material, corrugated cardboard, medium density, or other materials used to form a door core. Additional components, such as lock blocks and hinge blocks, may also be assembled into the door assembly 10.

The skins 12, 14 of the molded door assembly 10 shown in FIG. 1 may be molded thin, usually between 2 and 7 millimeters. The thin profile of the skins 12, 14 contributes to a light weight assembly. When attached to opposite sides of the stiles 18 and rails 20, the assembly 10 has the thickness of a standard door. The thickness of the skins 12, 14 may be uniform, so that the design portions 16 and the non-design planar portions have a substantially uniform density.

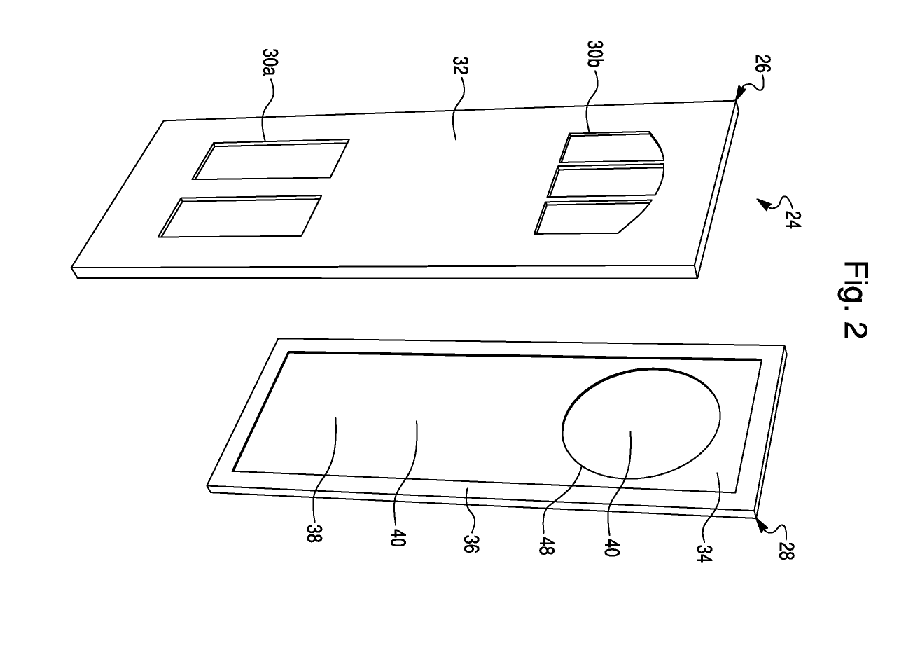

FIG. 2 depicts an exemplary embodiment of a door 24 with a reduced number of door components compared to the door assembly 1 of FIG. 1. The door 24 includes identical first and second door panels 26, 28 each having a respective thickness, wherein the thickness of the first door panel 26 may equal the thickness of the second door panel 28. The total thickness of the door 24 is thus established by the aggregate thickness of the first and second door panels 26, 28. The door 24 of FIG. 2 is frameless. That is, there is no frame to contribute to the thickness of door 24. The door panels 26, 28 may be formed from a wood composite material, for example medium density fiberboard (MDF), high density fiberboard (HDF), particle board, or oriented strand board (OSB). Variations of these boards as well as other types of wood composites boards may also be used for forming the door panels 26, 28.

The door panels 26, 28 may contain one or more design elements 30a, such as molded or contoured features. As best shown in FIG. 2, an example of such a design element 30a is an ornamental interior door molding. Various configurations of design elements 30a, including type, amount, shape, size, and location may be utilized. The door panels 26, 28 have an exterior surface 32 and an opposite interior surface 34. The door panels 26, 28 may be further separated into an outer (or peripheral) region 36 and an inner (or central) region 38. The outer region 36 and inner region 38 should be understood to extend through the thickness of the door panels 26, 28, but may be referred to as a section of the exterior surface 32 or the interior surface 34 for clarity.

The door panels 26 and 28 may be secured to one another, such as with an adhesive such as by polyvinyl acetate or hot melt adhesive, to form an assembled door 24. At least a portion of the interior surfaces 34 of the door panels 26, 28 are placed in contact with one another. For example, in the embodiment illustrated in FIG. 2, when the door panels 26, 28 are contacted to form the door 24, it is the outer regions 36 that contact one another. In FIG. 2, the outer regions 36 extend continuously along the upper and lower edges and opposite sides of the peripheries of the door panels 26, 28. The outer regions 36 may have a combined thickness substantially equivalent to that of typical rail and stile members. For example, typical stiles may be approximately 10 inches or less in width running the length of the door.

Depending on the different design elements 30a and required characteristics of the door 24, the inner regions 38 of the door panels 26, 28 may also contact one another when the door panels 26 and 28 are assembled together. Alternatively, the inner regions 38 can include thickened portions, particularly extending parallel to the longitudinal and lateral edges of the door panels 26, 28, to act as internal rail and stile members or to take the place of a core member. In this frameless embodiment, no separate rail or stile components are required.

In an exemplary embodiment, the door panels 26, 28 have a nearly identical thickness, each making up half the thickness of the door 24. Typical exterior doors usually have a thickness of approximately 1.375 inches, meaning the individual door panels 26, 28 have a width of approximately 0.6875 inches each. Exterior doors may also have a thickness of approximately 1.75 inches, in which case the individual door panels would be approximately 0.875 inches each. The present invention, however, may be utilized with a variety of doors, such as interior doors and fire doors, the thicknesses of which may vary in sizes, for instance, between 0.5 inches and 2 inches.

Instead of completely eliminating stile and rail members 18, 20, various exemplary embodiments may alternatively reduce their size, in particular their thickness. In such embodiments, the door panels 26, 28 may include outer regions 36 having a combined thickness that is less than the desired total thickness of the door 24. For example, the outer regions 36 of the door panels 26, 28 may have a thickness that, while greater than standard 0.125 inch panels, is less than 0.6875 inches (for a 1.375 inch door), leaving sufficient room to accommodate thin stiles and rails (not shown). In an exemplary embodiment, the stiles and rails have a thickness of between 0.125 and 0.75 inches. This reduced thickness, achieved by the provision of the outer regions 36, allows for extra stability to be provided to the assembled door 24, while still reducing material costs, reducing the overall weight of the door 24, and reducing costs associated with handling, shipping, and storing the door 24 and the various extra components. It should be noted that various exemplary aspects described herein may be utilized with door skins 12, 14 or typical door facings as will be understood by one of ordinary skill in the art.

In addition to reducing the number of components used to form the door 24, in certain exemplary embodiments the molded door panel 26, 28 can be further processed to provide a variety of different exterior door appearances and designs, such as differing numbers and arrangements of door lites. Generally, there is consumer demand for a wide variety of design features, and to meet consumer demand it is desirable to provide a molded door panel that can be processed into a wide variety of door designs. For example, to accommodate consumer demand, it is preferable to provide a variety of different door panel appearances having different quantities and arrangements of door lites.

In an exemplary embodiment, the door panels 26, 28 are formed from the same mold die so as to be virtually identical. Each of the door panels 26, 28 may be modified by post processing to form any of a wide selection of different design elements and door lite arrangements.

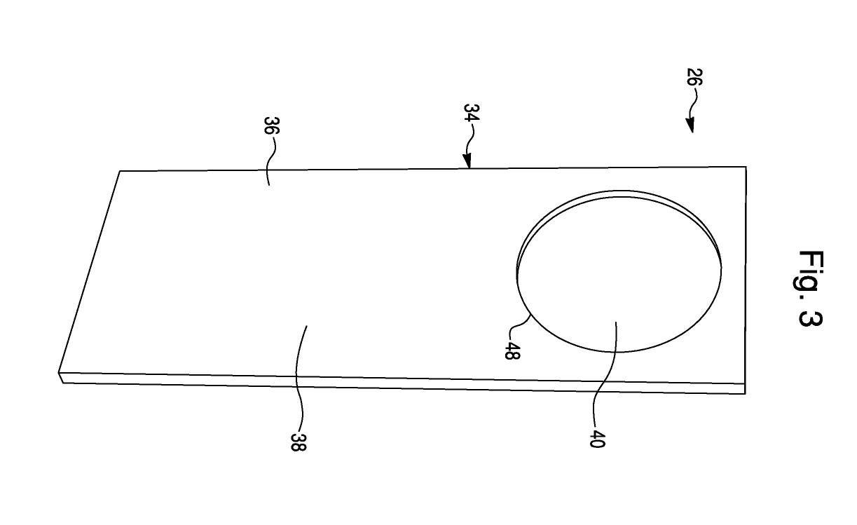

As best shown in FIGS. 2 and 3, a door lite receiving region 40 may be formed in the door panel 26, for example through a molding procedure. The door lite receiving region 40 may be formed in the molding process by compressing or embossing a portion of the door panel 26 corresponding to the door lite receiving region 40 to a greater extent than the surrounding portion of the door panel 26. Such molding and embossing technical can impart a greater density to the door lite receiving region 40 than the surrounding region, e.g., the region outside boundary edge 48 of the door lite receiving region 40, as well as the rest of the panel 26.

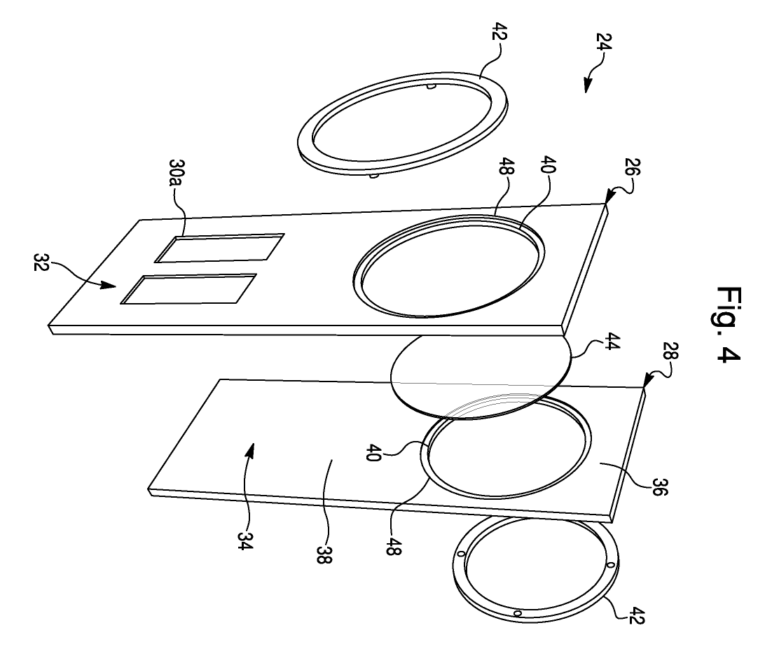

Referring to FIG. 4, density variations may also be present in the case of design elements 30a, 30b, which likewise can be formed during molding or embossing. The design elements 30a, 30b are shown formed in the exterior surface 32, whereas the door lite receiving region 40 is shown formed in the interior surface 34. Differences in density, however, may depend on the type of design elements 30a, 30b.

FIG. 4 shows the door lite receiving region 40 further processed to remove a circular portion of a diameter slightly less than the diameter of the outside boundary edge 48, leaving so much of the door light receiving region 40 as to form an annular shoulder or continuous rim extending radially inward of the boundary edge 48. The inner edge of the continuous rim defines an opening. In various exemplary embodiments, the density of the remaining shoulder or rim portion of the door lite receiving region 40 is sufficient to receive and secure a frame assembly 42 and a door lite 44 as best shown in FIG. 4. For example, the door lite receiving region 40 may be sufficiently compressed to have a screw pull retention value of 200 lbs or more. In other embodiments, the door lite door light receiving region 40 has a density sufficient to support a door lite 44 without a frame assembly 42. The door lite receiving region 40 may be compressed and have an elevated density compared to at least one other portion of the door panel 26, such as the exterior portion 36. In various embodiments, the door lite receiving region 40 is compressed more than the outer region 36 and the remainder of the inner region 38.

While the door lite receiving region 40 is depicted as a circular region in FIGS. 2-4, the shape of the door lite receiving region 40 may be an oval, obround, square, rectangular, an arch, polygonal, or a variety of other shapes as will be understood by one of ordinary skill in the art.

The door panels 26, 28 have similar or identical door lite receiving regions 40, so that when the panels 26, 28 are joined together with their respective interior surfaces 34 facing one another, the door lite receiving regions 40 align with one another. The door lite receiving regions 40 may be molded into the interior surface of the panels 26, 28 so that they have no visible impression on the outer surface 32.

The opening, such as shown in FIG. 4, may be made before or after assembling the door panels 26, 28 together, although typically the opening is made after the door panels 26, 28 have been assembled. Upon assembling the door 24, a portion of the door panels 26 and 28 encompassed by the door lite receiving regions 40 is removed to form the opening. The door light 44 is placed in the opening. The shape and size of the opening depends on the design of door lite 44 desired by the consumer. In an exemplary embodiment, enough of the compressed door lite receiving region 40 remains to receive the edge of the door lite 44, either accompanied with a frame assembly 42 or on its own, i.e., a frameless door lite. The remaining portion of the door lite receiving region 40 may have a reduced thickness, and therefore greater density than the surrounding portions, making it better suited to receive and secure the door lite 44.

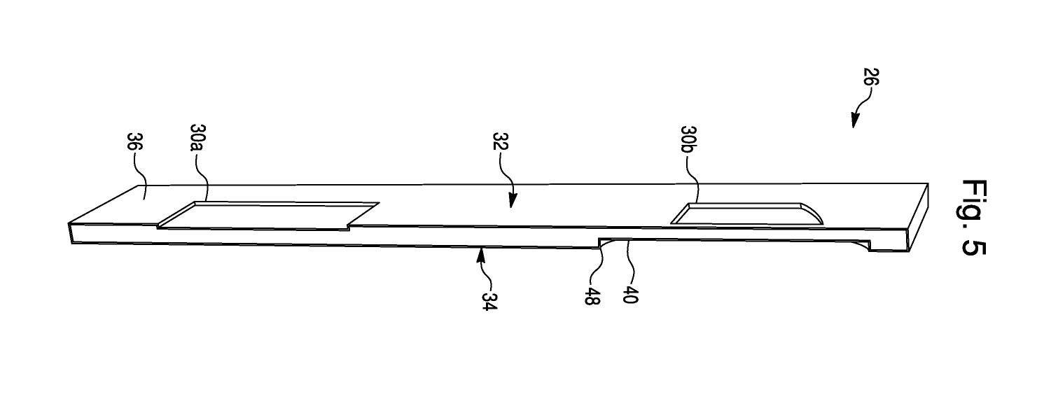

Although the door panels 26, 28 are designed to facilitate processing of door lites, the door panel 26 may be used either with or without a door lite 44. In the embodiment depicted in FIGS. 2 and 5, the door lite receiving region 40 formed on the interior surfaces 34 of the door panels 26, 28 is directly opposite a design element 30b formed on the exterior surfaces 32. However, no opening is formed through the door lite receiving regions 40 of either of the door panels 26, 28. If a consumer desires a regular paneled door without a door lite, no cutting operation is performed and the door is sent on for processing without a door lite. On the other hand, if the consumer wishes for the door 24 to possess a door lite, the door panels 26, 28 are constructed in such a manner that they may be post-mold processed to provide any of multiple different door lite designs. More specifically, after the door lite design is chosen by the consumer, an opening having a size and shape desired by the consumer is formed in the panel 26 and the door lite 44 is placed into the door. All of the design elements 30b may be removed during formation of the opening. Alternatively, a portion of the design element 30b may be left to border the opening formed for the door lite 44. As best shown in FIG. 5, the exterior surface 32 of the panel 26 may contain additional design elements 30a not located in the vicinity of the door lite receiving region 40 and therefore remain as part of the completed door 24, even after the opening is formed in the door lite receiving region 40.

The door lite 44 may be placed into the door 24 in a variety of ways. As the embodiment illustrated in FIG. 4, a frame assembly 42 is attached to the peripheral portions of door lite region 40. The frame assembly 42 surrounds the door lite 44, holding it in place. Different frames and methods of attachment are described in U.S. Pat. Nos. 6,434,898; 6,622,449; and 7,721,501, as well as U.S. Published Patent Application 2005/0193655, all of which are incorporated herein by reference to describe various frame modifications but are in no way meant to otherwise limit or affect the disclosure set forth herein.

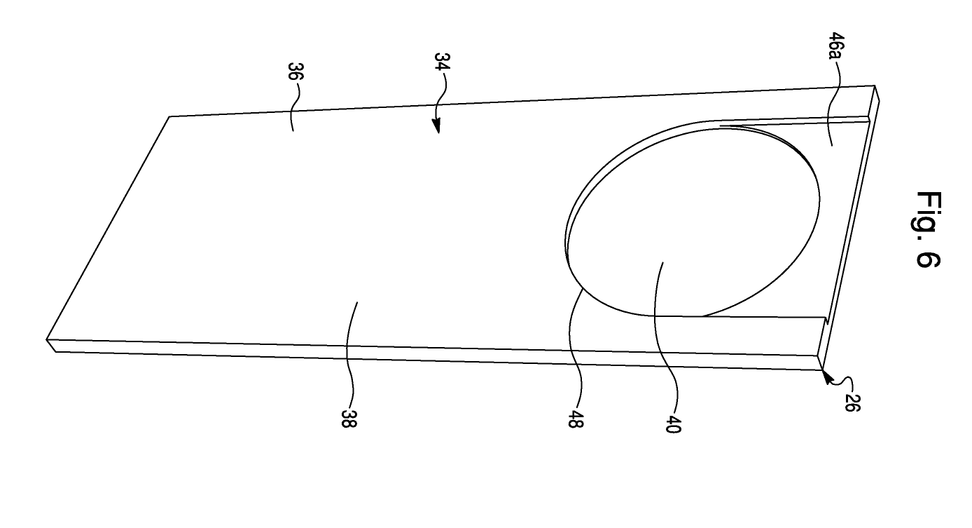

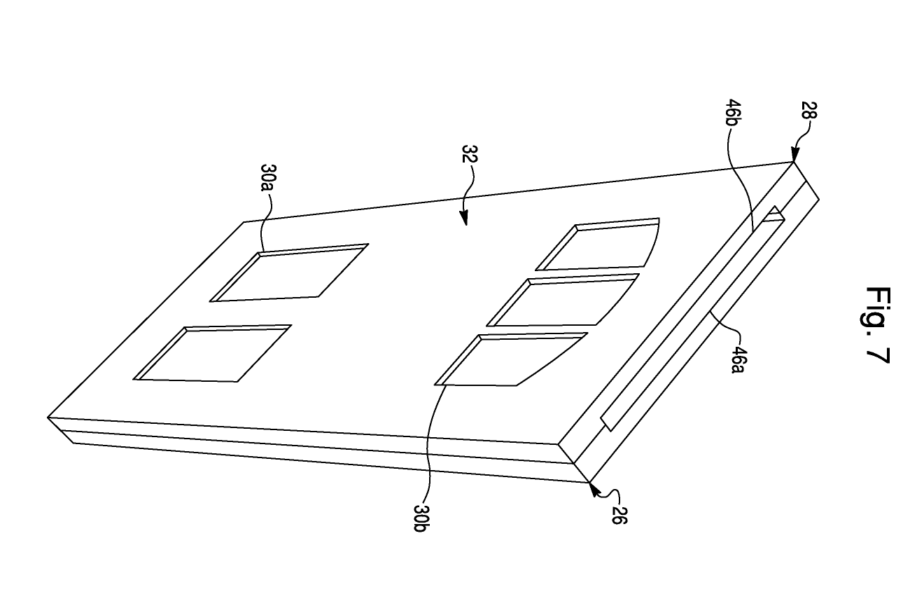

In other exemplary embodiments, as best shown in FIGS. 6 and 7, a slot 46a (or channel) is formed in the top of the door panel 26. The slot 46a may be formed during the molding of the door panel 26 or in a subsequent process. This slot 46a of this embodiment extends from the top of the door panel 26, although it should be understood that the slot 46a may extend from the bottom or laterally from either side edge of the door panel 26. The slot 46a of door panel 26 aligns with a similar or identical slot 46b in the second door panel 28. When the door panels 26, 28 are placed together, the slots 46a, 46b create an entrance in the top of the door for allowing insertion of the door lite 44. Typically, the door lite 44 is placed into the door through the entrance formed by the slots 46a, 46b after a portion of the door lite receiving region 40 has been removed to form an opening. In an exemplary embodiment, the slots 46a, 46b are large enough to accommodate the largest door lite 44 that may be chosen by a consumer. This enables any possible door lite 44 to be placed into the completed door assembly.

After the door lite 44 has been placed into the door 24, the entrance formed by the slots 46a, 46b may be covered, filled, or both to mask the entrance. The entrance may be masked by edge banding, injecting a foam material into the entrance, or placing an insert in the entrance. In an exemplary embodiment, where the slots 46a, 46b are formed after the molding of the door panel 26, the process to form the slots 46a, 46b may maintain the structural integrity of the removed material so that it can be used as the insert. In various exemplary embodiments the removed material is maintained as a single piece or two pieces, though more than two pieces may also be used. After the door lite 44 is placed into the door 10 through the entrance created by slots 46a, 46b, the initially removed material may be placed back into the entrance. The removed material may be held in place through adhesives, mechanical fasteners, or any other suitable method. This allows what would normally be waste material to be reused.

Additionally, the door may utilize a frame having any one of, or a combination of, first and second stiles 18, and first and second rails 20 as discussed above. Where a frame is used in connection with the embodiment of FIG. 6, the door panels 26, 28 may be assembled around the two stiles 18 and the bottom rail 20. If no door lite 44 is desired, the top rail 20 may be placed into the finished assembly at any given time. If a door lite 44 is desired, the door lite region 40 can be removed and the door lite 44 slid into the top of the assembled door 24. The top rail 20 may then be attached to the door, filling or concealing the entrance created by the slot 46. In this instance, the top rail 20 may be given a structure, for example a groove or a slot in its bottom surface, to interact with the door lite 44, securing it in place. The completed door may also utilize only a top rail 20 to fill the entrance created by the aligned slots 46a, 46b.

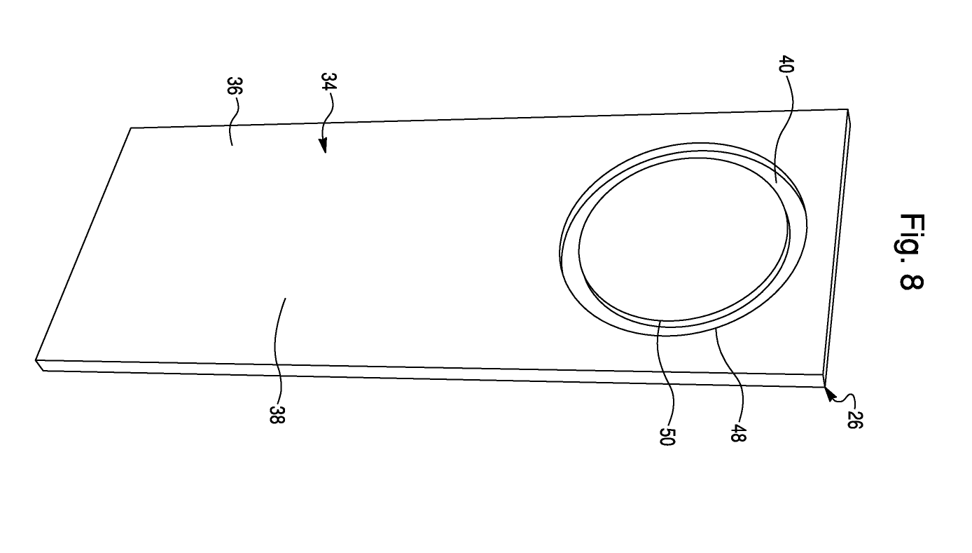

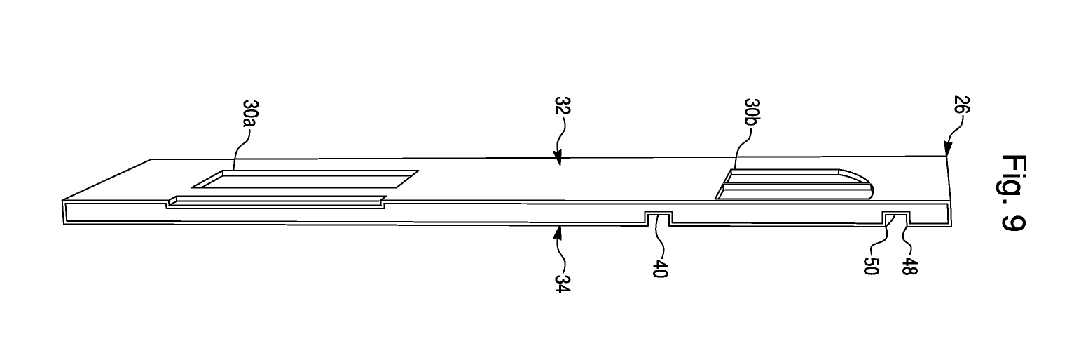

In various exemplary embodiments, the door lite region 44 is continuous and has only the boundary edge 48. In other various exemplary embodiments, the door lite region 44 is non-continuous. As best shown in FIGS. 8 and 9, the door lite region may have a boundary edge 48 and an inner edge 50. While shown as a ring shape in FIGS. 8 and 9, a door lite receiving region 40 having a boundary and inner edge 48, 50 may possess any possible shape. The space between the boundary edge 48 and the inner edge 50 is compressed, while the area enclosed by the inner edge 50 remains not as compressed as the edge 48. The space between the boundary and inner edges 48, 50 may be varied depending on the application. Additionally, the sizes (such as the diameter in the illustrated embodiments) of the boundary and inner edge 48, 50 may vary. For example, the combination of the boundary and inner edge 48, 50 may be sized so that the area encircled by the boundary and inner edge 48, 50 contains a design element 30b on the opposite exterior surface 32. In this way, when the uncompressed area is removed from the interior surface 34, and thus the design element 30b is removed from the exterior surface 32, the remaining compressed region between the boundary and inner edge 48, 50 is positioned to secure a door lite 44.

Forming the door lite region 44 to have a boundary and inner rim/shoulder 48, 50 can provide a number of advantages. Because only the area between edges 48 and 50 is compressed, the total material compressed during processing is reduced, and hence lower pressures are needed in the molding process. Additionally, the non-compressed material will have a lower density, making the material easier to remove. Having a thicker door lite region 44 may allow a deeper or more sharply defined design element 30b to be placed into the outer surface 32.

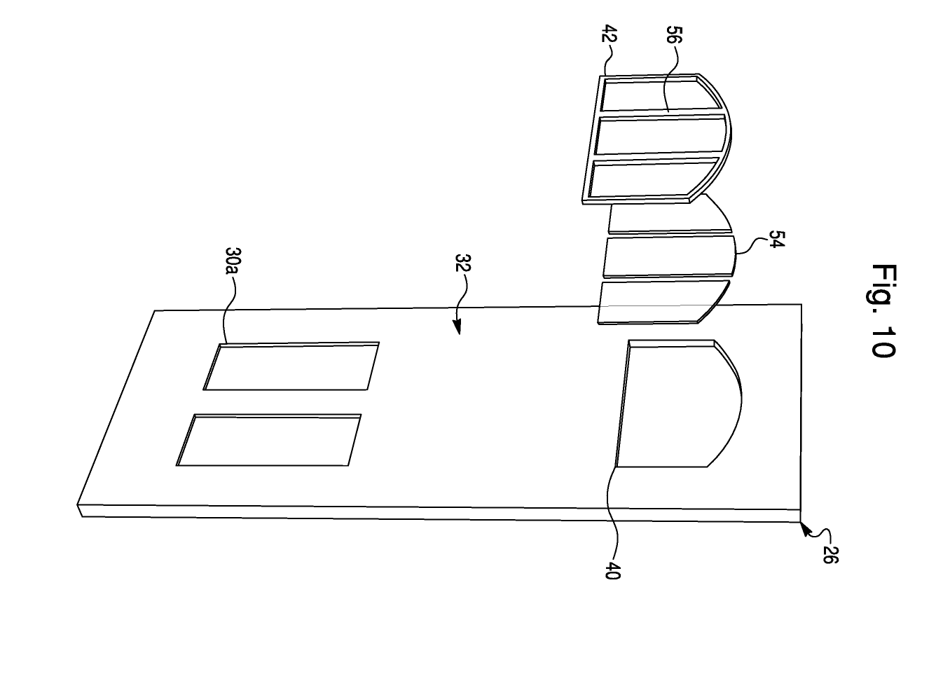

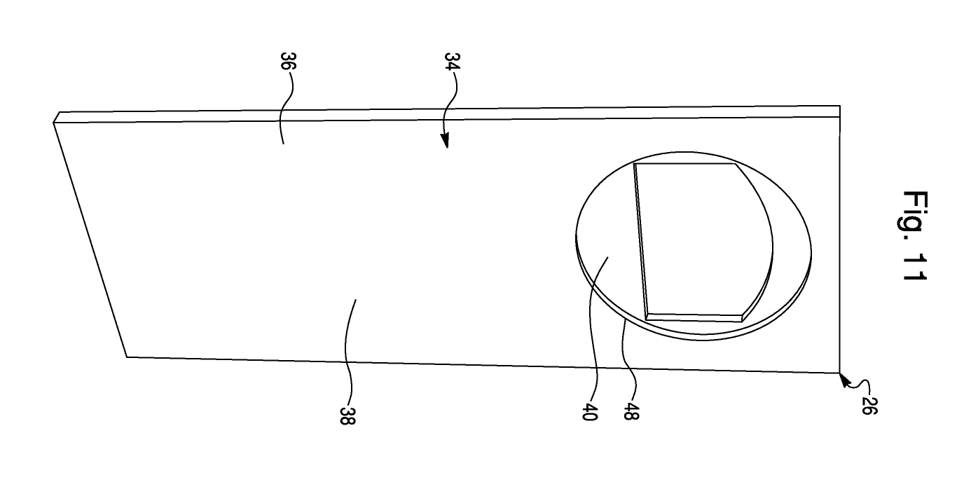

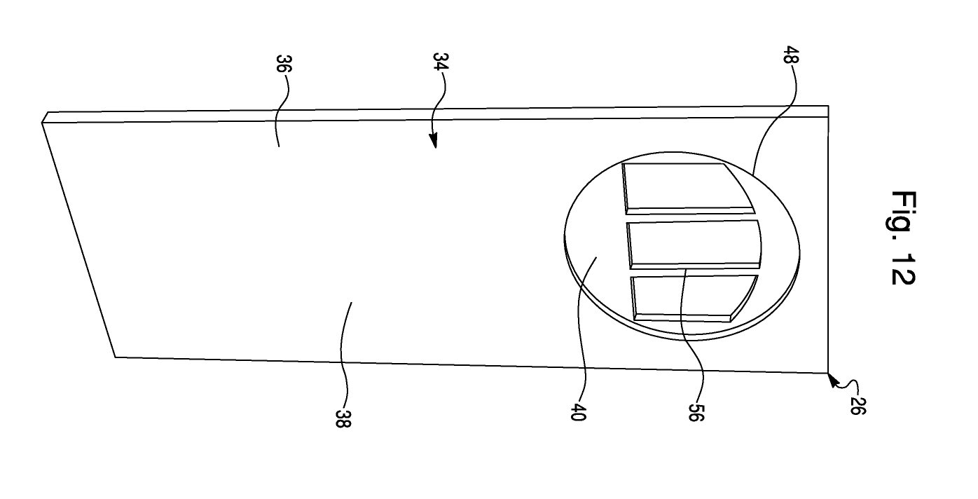

As best shown in FIGS. 10 and 11, the door lite 44 may be a single piece of glass or other translucent or transparent material, or it may comprise a number of individual pieces. In an exemplary embodiment, a multiple-piece door lite 54 may be used. When installing the multiple-piece door lite 54, a portion of the door lite receiving region 40 large enough to fit a single lite frame assembly 42 may be removed. The frame and the multiple-piece door lite 54 are then installed. The frame 42 may have muntins 56 separating the individual panes, as well as other elements such as mullions, window stiles, or window rails. In an alternative embodiment, as best shown in FIG. 12, only sections of the door lite region 40 sufficient to house the individual elements of the multiple-piece door lite 54 are removed. This allows the remaining portions of the door lite receiving region 40 to separate the pieces of the door lite 54, such as with muntins 56 or mullions (not shown). Additionally, this embodiment may utilize multiple individual frames 42 for each pane, or the remaining portions of the door lite region 40 may act as the frame as discussed above.

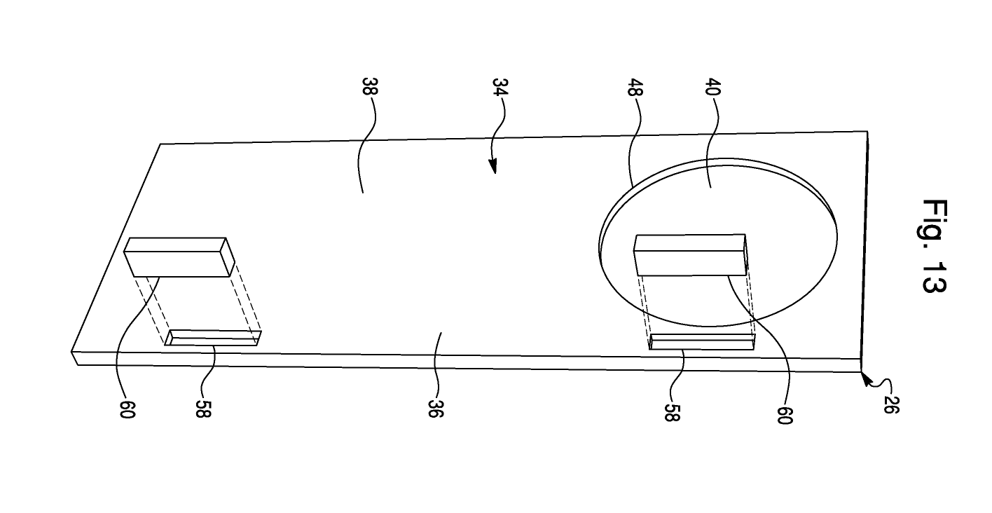

In various exemplary embodiments, the density of the outer region 36 is sufficient to retain screws associated with a hinge assembly as well as a door knob assembly (not shown) so that a finished door may be placed into operation with little assembly or modification required. For example, the outer region may have a density sufficient to provide a screw retention value of 200 lbs or more, for example up to 625 lbs. In certain instances, however, greater support may be needed for extra components. As best shown in FIG. 13, when extra support is needed, the door is provided with at least one insert region 58. For example, when more support is needed to attach hinges to a door, the panels 26, 28 may have corresponding insert regions 58 in locations typically associated with door hinges. The insert region 58 may be molded into the door or formed through a subsequent procedure such as routing. The insert region 58 is recessed into the door panel 26 to receive an insert 60, for example a wooden block. The insert regions 58 on the two panels 26, 28 align to create a cavity, into which the insert 60 may be placed when assembling the door.

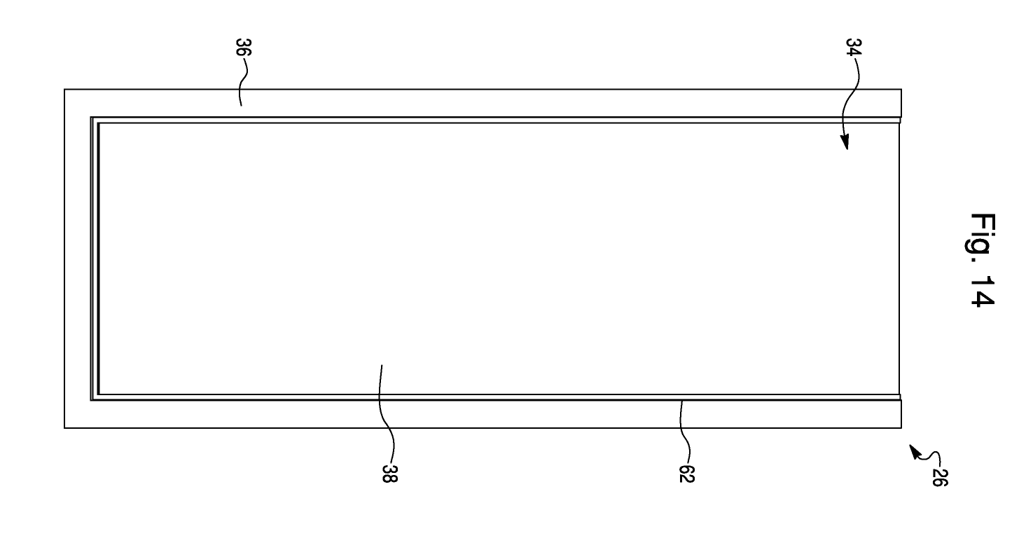

Various exemplary embodiments are also directed to a door panel 26 having a channel 62 molded into the interior surface 34 to retain the door lite 44. This feature is best shown in FIGS. 14-19. When a door lite 44 is desired, a door lite receiving region 40 may be removed and the door lite 44 is held in place, at least partially, through the cooperation of a channel 62 formed in a first and second panel 26, 28. Additionally mechanical fasteners, frames, or adhesives may be used to hold the door lite 44 in place as needed. A similar channel 62 or other structure may be used in conjunction with stile and rail members 18, 20 to assist in holding the door lite 44 in place. Various locations, sizes, and shapes of the channel 62 may be utilized. For example, though FIG. 14 depicts the channel 62 running a substantial length of the door panel 26, the channel 63 may only extend a portion of the door panel 26, for example the upper half or third of the door panel 26.

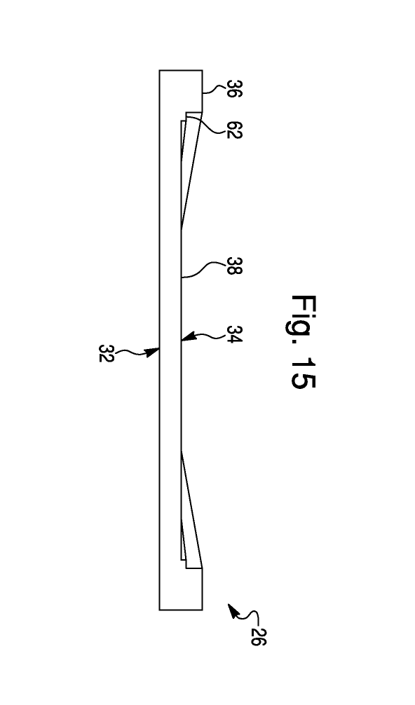

As best shown in FIGS. 14 and 15, the channel 62 may be molded into the door panel 26 so that it can be considered either part of outer region 36 or separating the outer region 36 and inner region 38. In this example, the inner region 38 is compressed more than and has a smaller thickness than the channel 62. As discussed above, when a door lite 44 is required, a section of the inner region 38 may be removed while enough is left to retain a door lite 44, in effect forming the channel 62 after the removal process. The channel 62 acts to frame the door lite 44.

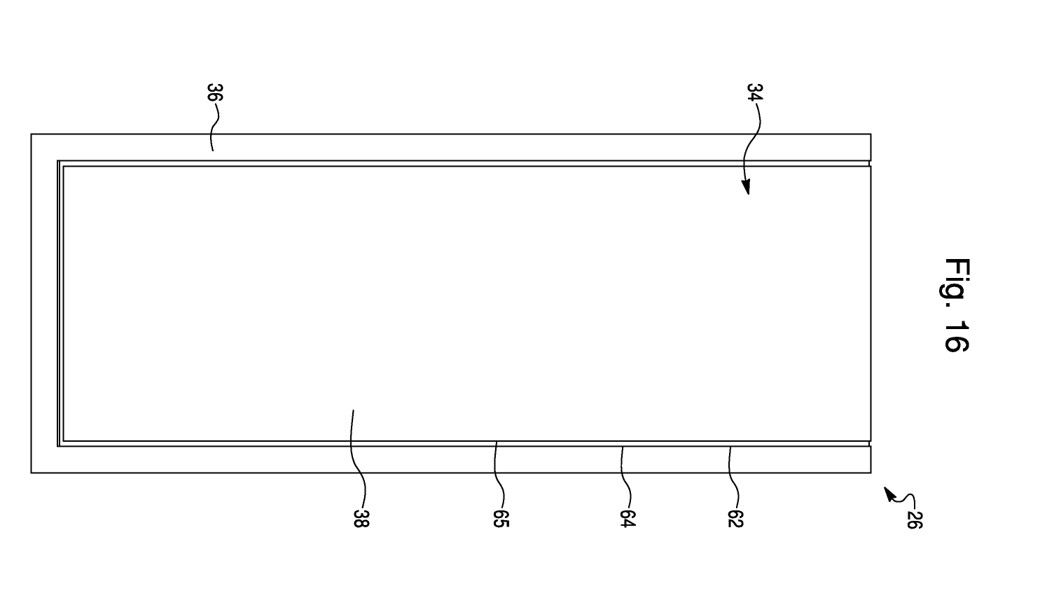

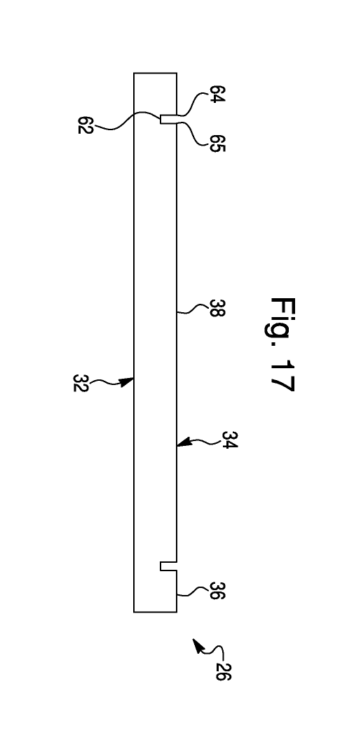

As best shown in FIGS. 16 and 17, the channel 62 may be molded into the door panel 26 so that it has a boundary outer edge 64 and an inner edge 65 similar to the boundary outer edge 48 and inner edge 50 described herein with respect to the door lite receiving region 40. In this instance, the inner region 38 has a thickness greater than the channel 62. In an exemplary embodiment the thickness is equal to the thickness of the outer region 36. If a door lite 44 is desired, necessary amounts of the inner region 38 may be removed and a door lite 44 can be either placed into the door panel 26 before joining the panels 26, 28, or it can be placed into the assembled door 24 afterwards, such as through an entrance formed by slots 46a, 46b as best shown in FIG. 7.

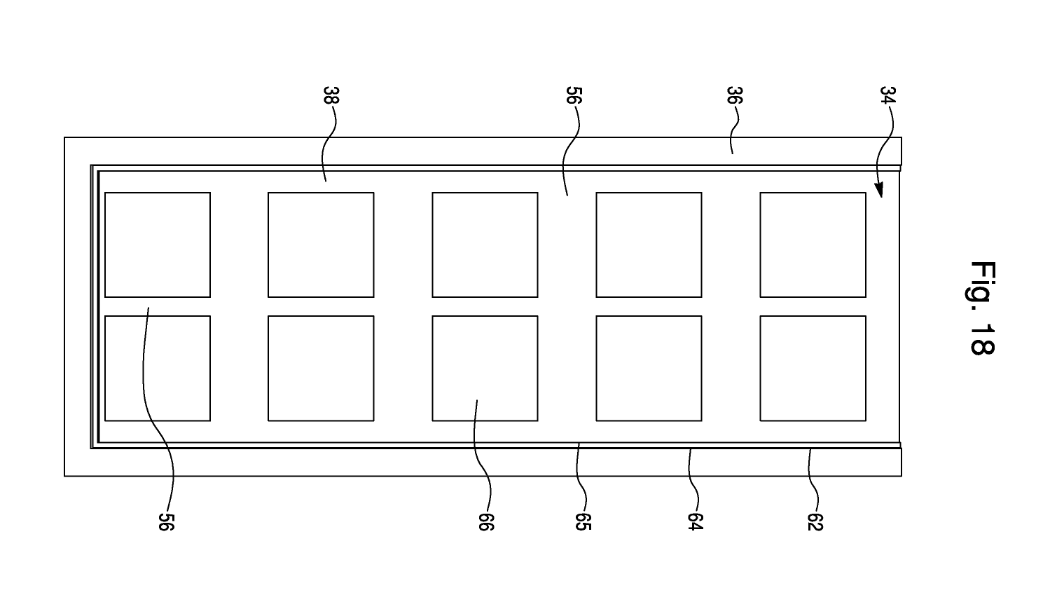

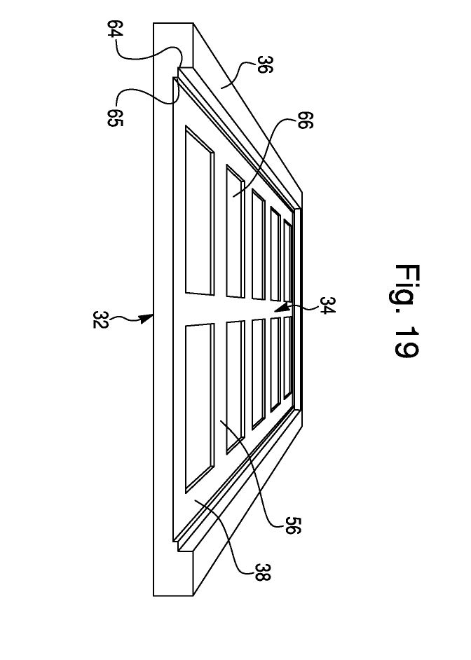

As best shown in FIGS. 18 and 19, the molded channel 62 can be used to create a French door. In this example, the channel 62 has a boundary edge 64 and an inner edge 65. The inner region 38 may have a thickness less than or equal to the channel 62. Panels 66 may be molded into the inner region 38. The thickness of the panels 66 may be less than, equal to, or greater than the inner region 38. To create a French door, the panels 66 are removed and a single sheet of glass or other glazing can be placed on the door panel 26. Additionally, if the first and second panels 26, 28 of the French door are already assembled, the sheet of glass/glazing may be inserted through an entrance similar to the one described above with respect to slot 46a. The remaining sections of the inner region 38 may act as muntins 56 to give the appearance of a number of individual separate panes of glass. Alternatively, individual channels 62 may be molded into the inner region 38 around panels 66. In this way, separate individual panes of glass may be inserted into the door panel 26 and held in place.

In various exemplary embodiments, channel 62 greatly enhances the flexibility of the door design, while also reducing the complexity of making different individual doors and holding multiple components in inventory. For example, a single rectangular piece of glass can be held in inventory. As different designs of door lites 44 are ordered, the particular designs can be removed from the door panels 26, 28. The single shape and size of glass door lite 44 may then be placed into the door panels 26, 28 and held in place, for example with channel 62. The outer appearance of the finished door lite 44 matches the shape of the material removed from, i.e., the openings in, the door panels 26, 28. Therefore a single shape and size of glass may be inventoried and used to create door lites 44 having a variety (circular, semi-circular, oval, square, rectangular, etc.) of designs. This not only reduces the expense and complexity of multiple inventories, but reduces the cost of ordering different, sometimes intricate, cuts of glass. It should be noted that this advantage may also be achieved with the various other exemplary embodiments described herein.

Another exemplary embodiment provides a method of making a door assembly. The door panels 26, 28 may be formed from a first mat of material made from resin bound fibers such as MDF. The mat has an initial thickness which may vary depending on the final desired thickness and density of the door panel 26. The mat may be molded to have any of the configurations described herein. Alternatively, the door panels 26, 28 are not molded directly from non-solid mats or bats to form three-dimensional molded panels as in standard molded door manufacturing. Instead, flat solid composite blanks that have already been pressed into their compressed rectangular flat shape are provided, pre-heated, moistened, and then reformed in a mold press in order to result in post-molded reformed panels 26, 28. In other words, flat blanks are post-formed into molded door facings. By reforming flat pressed blanks in such a manner, the prior door skin molding procedure (e.g. with dies, presses and the like that take non-solid bats and press them into molded skins) can be performed elsewhere or in advance. Thus, panels 26, 28 can be made more efficiently and cost effectively, and the resulting door 24 may have a strength of more than twice that of a door formed from standard molded skins, and more than twice that of standard flush or flat skin blanks.

Various other processes for molding panels 26, 28 have been developed and may be used in conjunction with the present invention. Examples of different methods that can be used to form the door panels 26, 28 may be found in U.S. Pat. Nos. 6,073,419; 6,079,183; 6,312,540; 6,318,989; 6,500,372; 6,588,162; 6,689,301; 6,868,644; 7,096,916; 7,195,686; and 7,426,806. Additionally, the panels 26, 28 may be molded to contain a variety of design elements 30a, 30b as are known in the art, as well as disclosed in the above-identified patents.

In the embodiment shown in FIGS. 2 and 3, the panel 26 is molded so that the exterior surface 32 has at least one design element 30a. The interior surface 34 is molded to have at least a door lite receiving region 40. As best shown in FIGS. 8 and 9, the door lite receiving region 40 may have only a boundary edge 48 or both a boundary outer edge 48 and an inner edge 50. The door panel 26 may also be molded to have a slot 46a, though the slot 46a may be formed through a subsequent operation such as milling, routing, cutting, or laser cutting. The molded door panel has an outer region 36 having a first thickness. A second panel 28 is then molded in a similar fashion, having a door lite receiving region 40. The second panel 28 may have an outer region 36 with a second thickness. In an exemplary embodiment the first thickness and the second thickness are equal to each other. In various other exemplary embodiments the first and second thicknesses vary. The panels may also have an inner region 38, which may vary in size, shape, and thickness as discussed in greater detail above.

In certain instances, the collective thickness of the panels 26, 28 after molding may not be of a suitable dimension for forming the finished door. In these cases, one or more of the panels 26, 28 may undergo a subsequent operation to remove material, reducing the thickness. The subsequent operation may be further molding, sanding, trimming, routing, milling, or planing. Various other methods may be used to remove material as will be understood by those of ordinary skill in the art upon viewing the teachings set forth herein.

As best shown in FIG. 7, after the desired thickness has been reached, the panels 26, 28 are joined together to form a completed door assembly 10, such that the thickness of the outer region 36 of the first panel 26 and the thickness of the outer region 36 of the second panel 28 equal the total thickness of the final door assembly 24. The panels may be joined by an adhesive, by mechanical fasteners, or by other suitable methods. As discussed above, the panels 26, 28 are joined together so that at least a portion of their interior surfaces 34 are in direct surface to surface contact. In various exemplary embodiments the outer region 36 of door panels 26, 28 are in contact with each other. As discussed above, the inner region 38 of the door panels 26, 28 may be compressed or of equal thickness as that of the outer region 36. In an exemplary embodiment, when the door facings are assembled there are no gaps present along the outer edges of the door panels 26, 28. The door panels 26, 28 may also be assembled with stile and rail members 18, 20 as discussed in greater detail above.

After the panels 26, 28 are joined together, a portion of the door lite receiving region 40 may be removed from each door panel 26, 28. Door lite receiving region 40 may be removed via, for example, milling, routing, cutting, or laser cutting. As best shown in FIGS. 4 and 10, a door lite 44, or a multiple-piece door lite 52, either with or without a frame assembly 42 may then be placed into the door 24. The door lite 44 can be inserted through the opening formed in the door lite receiving region 40 or it may be inserted through the entrance created by slots 46a, 46b. In various exemplary embodiments utilizing slots 46a, 46b, in a subsequent step the entrance is filled, as discussed above.

As best shown in FIG. 13, the panels 26, 28 may be formed having at least one insert region 58. As discussed herein, the insert regions 58 receive an insert 60 which provides extra support for additional hardware associated with the door, such as a hinge assembly. When making the door 24, inserts 60 are placed into the insert regions 58 of one of the panels 26, 28. The other panel will then be joined so that the insert regions 58 align to completely house the inserts 60.

As best shown in FIGS. 14-19, the door panels 26, 28 may be molded with a channel 62. This channel may have a boundary edge 64 and an inner edge 65. The channel 62 acts to hold a glass insert for a door lite 44 in place. As best shown in FIGS. 18 and 19, the door panels 26, 28 may also be formed with a variety of panels 66, molded into the interior surface 34. These panels 66 may then be removed to create a French door. A glass or other transparent or translucent insert may be placed into the door panels 26, 28 prior to their joining, or afterwards as through an entrance created by slots 46a, 46b.

Once assembled, additional operations may be performed to complete the door 24. This may depend on the initial material used and the final requirements of the door. For instance the door 24 may be stained, painted, or otherwise coated with a finishing substance. Additionally, a design or pattern may be applied to the door 24 such as through a printing, embossing, veneering, or laser engraving process. While certain exemplary embodiments seek to eliminate gaps or spaces between the door panels 26, 28 along their outer edges, it may be necessary or desirable, either for functional or aesthetic reasons, to apply banding to these outer edges. For example, banding may provide additional support to hardware associated with the final door assembly.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. Any exemplary embodiments or other features described herein may be combined with any other exemplary embodiments, or features described herein without limit to the manner and type of combination. This description is not necessarily intended to be exhaustive or to limit the invention to the precise embodiments disclosed. Additional embodiments are possible and are intended to be encompassed within this specification and the scope of the appended claims. The specification describes specific examples to accomplish a more general goal that may be accomplished in another way.

What is claimed is:

1. A door comprising:
a composite wood first door panel comprising a first exterior surface and an opposite first interior surface, the first interior surface comprising a first door lite receiving region having a first reduced thickness compared to at least one other region of the first door panel; and
a composite wood second door panel comprising a second exterior surface and an opposite second interior surface, the second interior surface comprising a second door lite receiving region having a second reduced thickness compared to at least one other region of the second door panel, the first and second door panels secured to one another with the first and second door lite receiving regions aligned with one another.

2. The door of claim 1, wherein the first exterior surface comprises a design element positioned opposite to the first door lite receiving region, wherein neither the design element nor the first door lite receiving region penetrate entirely through the first door panel.

3. The door of claim 1, wherein at least a portion of the door lite receiving region is removed to establish an opening through the first door panel.

4. The door of claim 3, further comprising a door lite positioned in the aligned first and second door lite receiving regions, wherein the door lite extends across at least a portion of the opening.

5. The door of claim 4, further comprising a frame surrounding a perimeter of the door lite.

6. The door of claim 4, wherein the door lite comprises multiple pieces.

7. The door of claim 4, wherein the shape of the door lite is different from the shape of the opening.

8. The door of claim 1, wherein the first door lite receiving region comprises a boundary outer edge and an inner edge.

9. The door of claim 1, wherein the first panel and the second panel are identical to one another.

10. A door comprising:
a composite wood, molded first door panel comprising a first exterior surface and an opposite first interior surface, the first exterior and first interior surfaces each having a respective first inner region and a respective first outer region, the first inner region of the first interior surface being molded to establish a first door lite receiving region having a first reduced thickness compared to at least one other region of the first door panel having a first thickness; and
a composite wood, molded second door panel comprising a second exterior surface and an opposite second interior surface, the second exterior and second interior surfaces each having a respective second inner region and a respective second outer region, the second inner region of the second interior surface being molded to establish a second door lite receiving region having a second reduced thickness compared to at least one other region of the second door panel having a second thickness,
wherein at least a portion of the first interior surface of the first panel is in direct surface-to-surface contact with at least a portion of the second interior surface of the second panel to form the door, and wherein the first thickness and the second thickness combined constitute a total thickness of the door.

11. The door of claim 10, wherein the first and second door lite receiving regions have densities greater than densities of the first and second outer regions, respectively.

12. The door of claim 10, wherein the first exterior surface comprises a design element positioned opposite to the first door lite receiving region, wherein neither the design element nor the first door lite receiving region penetrate entirely through the first door panel.

13. The door of claim 10, wherein the first and second door panels contain respective slots aligned with one another to establish an opening through which a door lite may be inserted into the first and second door lite receiving regions.

14. A door comprising:
a molded, composite wood first door panel comprising a first exterior surface and a first interior surface, the first interior surface comprising a first channel extending from an edge of the first door panel;
a molded, composite wood second door panel comprising a second exterior surface and a second interior surface, the second interior surface comprising a second channel extending from an edge of the second door panel, the first and second channels being aligned with one another to form an entrance for receiving a door lite.

15. The door of claim 14, further comprising at least one design element molded into the first exterior surface of the first door panel.

16. The door of claim 15, further comprising at least first and second door lite receiving regions molded into the first and second interior surfaces, respectively, the first and second door lite receiving regions being aligned with one another and in communication with the first and second channels to receive the door lite through the entrance.

17. The door of claim 16, wherein at least portions of the first and second door lite receiving regions are removed to establish a door lite area with muntins.

18. A method of making a door panel comprising:
molding a wood composite blank having an interior surface and an exterior surface to form a door panel having a compressed door lite receiving region in the interior surface, the door lite receiving region having a reduced thickness compared to at least one other region of the door panel.

19. A method of making a door, comprising:
molding first and second wood composites into first and second door panels, the first and second door panels each having an interior surface with a door lite receiving region and an exterior surface;
securing the first door panel and the second door panel together to form a door, wherein at least a portion of the interior surfaces of the first and second door panels contacting one another and wherein the first and second door lite receiving regions are aligned with each other.

20. The method of claim 19, further comprising removing at least a portion of the door lite receiving regions to form an opening for a door lite.
